(19) United States
(12) Patent Application Publication
(10) Pub. No.: US 2026/0218858 A1
(43) Pub. Date: Jul. 30, 2026

(54) LIQUEFIED GAS SUPERCOOLING SYSTEM USING MIXED REFRIGERANT

(71) Applicant: HD KOREA SHIPBUILDING & OFFSHORE ENGINEERING CO., LTD., Seongnam-si, Gyeonggi-do (KR)

(72) Inventors: Min Gyun PARK, Seongnam-si, Gyeonggi-do (KR); Jae Jun LEE, Seongnam-si, Gyeonggi-do (KR); Jong Wan PARK, Seongnam-si, Gyeonggi-do (KR)

(21) Appl. No.: 19/146,523

(22) PCT Filed: Jan. 9, 2024
(86) PCT No.: PCT/KR2024/000433

§ 371 Date: Jul. 9, 2025

(30) Foreign Application Priority Data
Jan. 9, 2023 (KR) 10-2023-0003084
Sep. 22, 2023 (KR) 10-2023-0127311
Jan. 9, 2024 (KR) 10-2024-0003555

(51) Int. Cl. F17C 13/00

(52) U.S. Cl. CPC F17C 13/002; F17C 2221/033; F17C 2223/0169; F17C 2227/0355

(57) ABSTRACT

The present invention relates to a liquefied gas supercooling system for supercooling a liquefied gas using a mixed refrigerant, the system comprising: a compressor; a separator; a fourth line through which the liquid-phase refrigerant separated by the separator flows by passing through a first pressure reduction valve; a fifth line through which the gas-phase refrigerant separated by the separator flows by being reintroduced to a first heat exchanger, a second heat exchanger, a second pressure reduction valve, and the second heat exchanger; a sixth line through which the mixed refrigerant joined from the fourth line and the fifth line flows by passing through the first heat exchanger, the compressor, and the separator; and a freezing prevention unit for controlling the temperature of the mixed refrigerant in the fifth line or the sixth line.

### CROSS-REFERENCE TO RELATED APPLICATION

This application claims the benefit of priority under 35 U.S.C. § 119(a) to Korean Patent Application Nos. 10-2023-0003084 filed on Jan. 9, 2023, 10-2023-0127311 filed on Sep. 22, 2023, and 10-2024-0003555 filed on Jan. 9, 2024, the entire contents of which are incorporated herein by reference.

### TECHNICAL FIELD

The present disclosure relates to a liquefied gas supercooling system using a mixed refrigerant.

### BACKGROUND ART

When natural gas is liquefied, its volume is reduced, making it easy to store and transport. Natural gas in this state is called liquefied gas. For example, LNG among liquefied gases has a liquefaction temperature of −163° C. at atmospheric pressure, so a storage tank with excellent insulation performance is used to maintain an extremely low temperature.

However, it is impossible to completely block heat inflow from the outside into the storage tank, and when heat is introduced, the liquefied gas inside the storage tank vaporizes, generating boil off gas (BOG). When the BOG occurs, the existing liquefied gas changes into gas to increase its volume and increase the pressure inside the storage tank, which leads to increase a risk of explosion. In addition, since the amount that may be transported decreases as the liquefied gas vaporizes, the economic losses occur.

Various methods are being studied to solve the problems caused by BOG. Representatively, there is a method of re-liquefying vaporized natural gas and a method of supercooling liquefaction.

Both of the above methods utilize a refrigeration cycle that cools natural gas through the circulation of a refrigerant, and methods such as increasing efficiency through a process change in the refrigeration cycle or increasing heat exchange efficiency by using a mixed refrigerant are being applied.

In particular, when the mixed refrigerant contains a heavy element such as pentane, during the heat exchange process, the temperature may drop excessively and the freezing may occur. When the freezing occurs, the device failure may occur, so it is necessary to control the temperature of the mixed refrigerant.

### DETAILED DESCRIPTION

### Technical Problem to be Solved

The present disclosure is to provide a liquefied gas supercooling system that increases the efficiency of a liquefied gas supercooling system and prevents freezing of a mixed refrigerant.

### Means for Solving the Problem

According to an embodiment of the present disclosure, a liquefied gas supercooling system for supercooling liquefied gas using a mixed refrigerant includes: a compressor that compresses the mixed refrigerant; a first separator that is provided at a rear end of the compressor to phase-separate the mixed refrigerant into a gaseous refrigerant and a liquid refrigerant; a first line through which the liquid refrigerant separated from the first separator flows through a first pressure reducing valve; a second line through which the gaseous refrigerant separated from the first separator flows through a first heat exchanger and a second separator; a second separator that is provided at a rear end of the first heat exchanger to phase-separate the mixed refrigerant separated from the first separator and passing through the second line into the gaseous refrigerant and the liquid refrigerant; a 2-1th line through which the gaseous refrigerant separated from the second separator flows by being re-introduced into a second heat exchanger, a second pressure reducing valve, and the second heat exchanger; a 2-2th line through which the liquid refrigerant separated from the first separator flows through a third pressure reducing valve; a third line through which the mixed refrigerant joined from the first line, the 2-1th line, and the 2-2th line flows through the first heat exchanger, the compressor, and the first separator, wherein, in the first heat exchanger, the gaseous refrigerant separated from the first separator and flowing along the second line, and the mixed refrigerant flowing along the third line may be heat-exchanged, in the second heat exchanger, the gaseous refrigerant separated from the second separator along the 2-1th line, the mixed refrigerant passing through the second pressure reducing valve along the 2-1th line, and the liquefied gas may be heat-exchanged, and the liquefied gas may be supercooled by the heat exchange in the second heat exchanger.

In one example, in the first pressure reducing valve, the liquid refrigerant separated from the first separator and flowing along the first line may be depressurized to lower its temperature, in the second pressure reducing valve, the mixed refrigerant passing through the second heat exchanger along the 2-1th line may be depressurized to lower its temperature, and in the third pressure reducing valve, the liquid refrigerant separated from the second separator and flowing along the 2-2th line may be depressurized to lower its temperature.

In one example, the liquefied gas supercooling system may further include: a junction connected to the first line, the 2-1th line, and the 2-2th line at a front end, and connected to the third line at a rear end, wherein the mixed refrigerant joined at the junction may flow along the third line and pass through the first heat exchanger, and the liquid refrigerant that passes through the first pressure reducing valve, the mixed refrigerant that passes through the second heat exchanger via the second pressure reducing valve, and the liquid refrigerant that passes through the third pressure reducing valve may be joined at the junction.

In one example, the liquefied gas supercooling system may further include: a junction connected to the first line, the 2-1th line, and the 2-2th line at a front end, and connected to the third line at a rear end; a bypass line that is branched from at least one of the second line and the 2-1th line; and a de-icing unit that controls the temperature of the mixed refrigerant on the 2-1th line or the 2-2th line by controlling an inflow of a relatively high-temperature mixed refrigerant through a bypass valve provided in the bypass line.

The de-icing unit may control a first temperature of the mixed refrigerant before entering the junction along the 2-1th line.

According to another embodiment of the present disclosure, a liquefied gas supercooling system for supercooling liquefied gas using a mixed refrigerant includes: a compressor that compresses the mixed refrigerant; a separator that is provided at a rear end of the compressor to phase-separate the mixed refrigerant into a gaseous refrigerant and a liquid refrigerant; a fourth line through which the liquid refrigerant separated from the separator flows through a first pressure reducing valve; a fifth line through which the gaseous refrigerant separated from the separator flows by being re-introduced into a first heat exchanger, a second heat exchanger, a second pressure reducing valve, and the second heat exchanger; a sixth line through which the mixed refrigerant joined from the fourth line and the fifth line flows through the first heat exchanger, the compressor, and the separator; and a de-icing unit that has a bypass line branched from at least one of the fifth line and the sixth line, and controls an inflow of a relatively high-temperature mixed refrigerant through a bypass valve provided in the bypass line and controls a temperature of the mixed refrigerant on the fifth line or the sixth line, wherein, in the first heat exchanger, the gaseous refrigerant separated from the separator and flowing along the fifth line, and the mixed refrigerant flowing along the sixth line may be heat-exchanged, in the second heat exchanger, the mixed refrigerant passing through the first heat exchanger along the fifth line, the mixed refrigerant passing through the second pressure reducing valve along the fifth line, and the liquefied gas may be heat-exchanged, and the liquefied gas may be supercooled by the heat exchange in the second heat exchanger.

In one example, the liquid refrigerant separated in the separator and flowing along the fourth line may be depressurized in the first pressure reducing valve to lower its temperature, and the mixed refrigerant passing through the second heat exchanger along the fifth line may be depressurized in the second pressure reducing valve to lower its temperature.

In one example, the liquefied gas supercooling system may further include: a junction connected to the fourth line and the fifth line at a front end and connected to the sixth line at a rear end, wherein the de-icing unit may control a fifth temperature of the mixed refrigerant before entering the first heat exchanger along the sixth line.

In one example, the de-icing unit may include a fifth bypass valve, and the fifth bypass valve may be provided on a fifth bypass line that is branched from at least one of the fourth line, the fifth line, and the sixth line and is connected to the fourth line at the front end of the first pressure reducing valve or the rear end of the first pressure reducing valve.

In one example, the liquefied gas supercooling system may further include: a junction connected to the fourth line and the fifth line at afront end and connected to the sixth line at a rear end, wherein the de-icing unit may control a sixth temperature of the mixed refrigerant through the second pressure reducing valve along the fifth line.

In one example, the de-icing unit may include a seventh bypass valve, and the seventh bypass valve may be provided on a seventh bypass line that is branched from the fifth line between the separator and the first heat exchanger and is connected to the fifth line at a front end of the second pressure reducing valve or a rear end of the second pressure reducing valve.

In one example, the liquefied gas supercooling system may further include: a junction connected to the fourth line and the fifth line at a front end and connected to the sixth line at a rear end, wherein the de-icing unit may control a seventh temperature of the mixed refrigerant that enters the compressor along the sixth line.

In one example, the de-icing unit may include an eighth bypass valve, and the eighth bypass valve may be provided on an eighth bypass line that is branched from the sixth line between the compressor and the separator and is connected to the sixth line between the first heat exchanger and the compressor.

In one example, the fourth line may pass through the first heat exchanger at a front end of the first pressure reducing valve, and in the first heat exchanger, a liquid refrigerant separated from the separator and flowing along the fourth line, a gaseous refrigerant separated from the separator and flowing along the fifth line, and a mixed refrigerant flowing along the sixth line may be heat-exchanged.

In one example, the de-icing unit may include a fifth bypass valve, and the fifth bypass valve may be provided on a fifth bypass line that is branched from at least one of the fourth line, the fifth line, and the sixth line and is connected to the fourth line at the front end of the first pressure reducing valve or the rear end of the first pressure reducing valve.

### BRIEF DESCRIPTION OF DRAWINGS

FIG. 1 is a diagram illustrating a liquefied gas supercooling system according to a first embodiment of the present disclosure.

FIG. 2 is a diagram illustrating a liquefied gas supercooling system according to a second embodiment of the present disclosure.

FIG. 3 is a diagram illustrating a liquefied gas supercooling system according to a third embodiment of the present disclosure.

FIG. 4 is a diagram illustrating a liquefied gas supercooling system according to a fourth embodiment of the present disclosure.

FIG. 5 is a diagram illustrating a liquefied gas supercooling system according to a fifth embodiment of the present disclosure.

FIG. 6 is a diagram illustrating a liquefied gas supercooling system according to a sixth embodiment of the present disclosure.

FIG. 7 is a diagram illustrating a liquefied gas supercooling system according to a seventh embodiment of the present disclosure.

FIG. 8 is a diagram illustrating a liquefied gas supercooling system according to an eighth embodiment of the present disclosure.

FIG. 9 is a diagram illustrating a liquefied gas supercooling system according to a ninth embodiment of the present disclosure.

FIG. 10 is a diagram illustrating a liquefied gas supercooling system according to a tenth embodiment of the present disclosure.

FIG. 11 is a diagram illustrating a liquefied gas supercooling system according to an eleventh embodiment of the present disclosure.

FIG. 12 is a diagram illustrating a liquefied gas supercooling system according to a twelfth embodiment of the present disclosure.

FIG. 13 is a diagram illustrating a liquefied gas supercooling system according to a thirteenth embodiment of the present disclosure.

FIG. 14 is a diagram illustrating a liquefied gas supercooling system according to a fourteenth embodiment of the present disclosure.

FIG. 15 is a diagram illustrating a liquefied gas supercooling system according to a fifteenth embodiment of the present disclosure.

### DETAILED DESCRIPTION

Hereinafter, some exemplary embodiments of the present disclosure will be described in detail with reference to exemplary drawings. It is to be noted that in giving reference numerals to components in each drawing, the same components will be denoted by the same reference numerals even though they are shown in different drawings. Further, in describing exemplary embodiments of the present disclosure, detailed descriptions of a related known construction or function will not be described in detail in the case where it is decided to obscure the understanding of exemplary embodiments of the present disclosure.

In addition, the terms a first, a second, A, B, (a), (b), and the like may be used in describing components in the embodiments of the present disclosure. These terms are only intended to distinguish the components from other components and do not limit the nature, order, sequence, etc. of the corresponding components. When a component is described as being “connected”, “coupled”, or “linked” to other component, it is to be understood that the component may be directly connected or linked to the other component, but another component may also be “connected”, “coupled”, or “linked” between each component.

In this specification, the front/rear, left/right, and up/down directions are referred to for convenience of description, and may be directions that are orthogonal to each other. However, these directions are determined relatively, and the up/down direction may not necessarily mean a vertical direction.

A liquefied gas supercooling system in a ship transporting liquefied gas will be briefly described through first to third embodiments.

### First to Third Embodiments

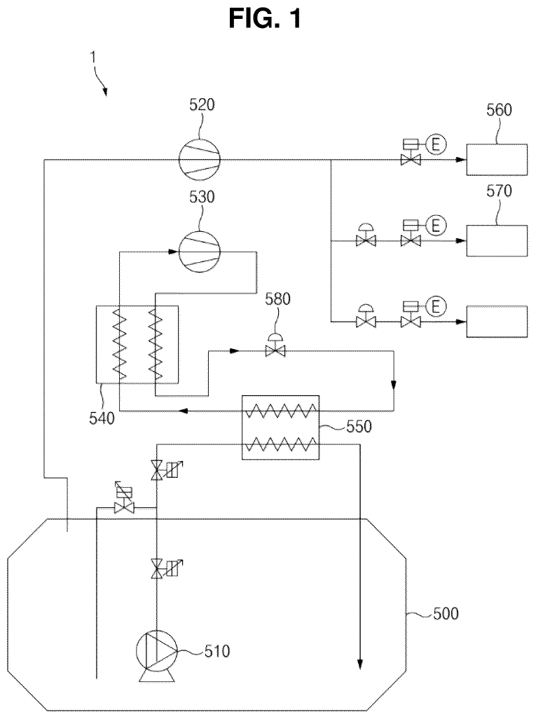

FIG. 1 is a diagram illustrating the liquefied gas supercooling system according to a first embodiment of the present disclosure.

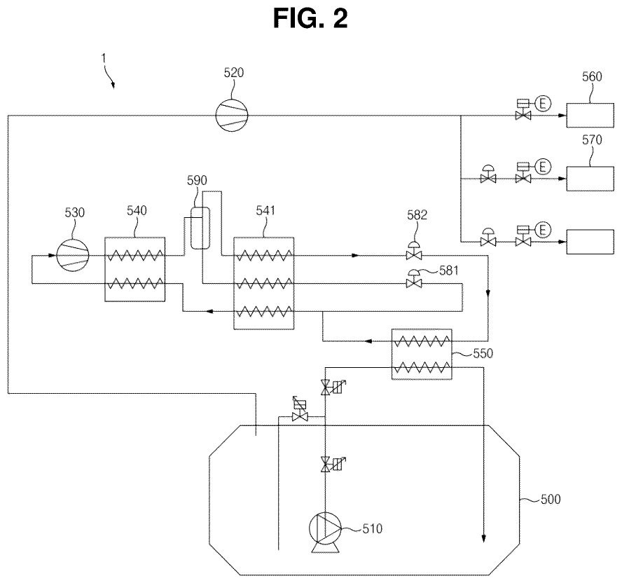

FIG. 2 is a diagram illustrating the liquefied gas supercooling system according to a second embodiment of the present disclosure.

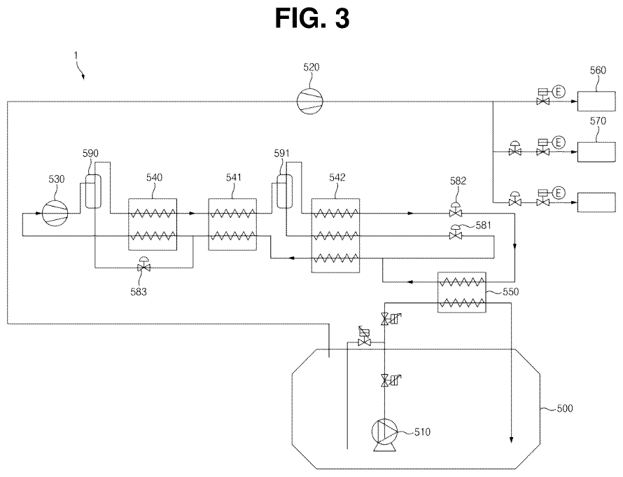

FIG. 3 is a diagram illustrating the liquefied gas supercooling system according to a third embodiment of the present disclosure.

In the case of a ship transporting liquefied gas, liquefied gas and BOG from which liquefied gas has evaporated are stored in a tank 500. When a ship is operating, BOG is extracted from the tank, pressurized to a predetermined pressure in a BOG compressor 520, and then supplied to a main engine 560 or a power generation engine 570 to be used as fuel. When the liquefied gas is excessively evaporated beyond the amount required as fuel, problems such as pressure increase in the tank occur, so the liquefied gas supercooling system is required to solve this problem.

By supercooling the LNG in a liquid state, the BOG compressor 520 may be omitted.

Referring to FIG. 1, the liquefied gas supercooling system 1 according to the first embodiment of the present disclosure includes a mixed refrigerant heat exchanger 540, a liquefied gas heat exchanger 550, a compressor 530, and a pressure reducing valve 580. The low-temperature mixed refrigerant that is cooled by circulating the cycle in the supercooling system exchanges heat with the liquefied gas extracted outside the tank 500 through a pump 510 in a liquefied gas heat exchanger 550 and supercools the liquefied gas. Even when the temperature of the mixed refrigerant that has completed the heat exchange with the liquefied gas increases, it has a relatively low temperature compared to the mixed refrigerant that has passed through the compressor. Therefore, by heat-exchanging the two mixed refrigerant in the mixed refrigerant heat exchanger 540, the temperature of the mixed refrigerant may be lowered without additional energy input from the outside, and the efficiency of the cooling cycle may be increased. The mixed refrigerant cooled in the mixed refrigerant heat exchanger 540 is cooled to an extremely low temperature through the pressure reducing valve 580 and then heat-exchanged with the liquefied gas again.

Referring to FIG. 2, the liquefied gas supercooling system 1 according to a second embodiment of the present disclosure includes a compressor 530, two mixed refrigerant heat exchangers 540 and 541, one liquefied gas heat exchanger 550, a separator 590, and two pressure reducing valves 581 and 582. Compared to the first embodiment, there is a difference in that a separator 590 is added so that the mixed refrigerant is separated into the gaseous refrigerant and the liquid refrigerant. This may prevent heavy elements such as oil or C4 and C5 contained in the liquid refrigerant from freezing in a low-temperature section while going through a cycle. The liquid refrigerant is not introduced into the liquefied gas heat exchanger 550 because there is a concern about cooling when heat-exchanging with liquefied gas, but is cooled in the pressure reducing valve 581 and then re-introduced into the mixed refrigerant heat exchanger 541. For the specific flow of the mixed refrigerant, refer to fourth to fifteenth embodiments below.

Referring to FIG. 3, the liquefied gas supercooling system 1 according to the third embodiment of the present disclosure includes a compressor 530, three mixed refrigerant heat exchangers 540, 541, and 542, one liquefied gas heat exchanger 550, two separators 590 and 591, and three pressure reducing valves 581, 582, and 583. Compared to the second embodiment, since there are two separators 590 and 591, oil or heavy elements that are not separated from the first separator 590 may be separated from the second separator 591, thereby further reducing the risk of freezing.

The mixed refrigerant cycle shown in FIGS. 1 to 3 is merely an example for explaining a liquefied gas supercooling system operating in a ship, and is not limited thereto. For example, the specific configuration of the mixed refrigerant cycle shown in FIGS. 1 to 3 may be replaced with configurations of the fourth to fifteenth embodiments described below.

The specific flow of the mixed refrigerant will be described below with reference to the fourth to fifteenth embodiments.

Hereinafter, the liquefied gas supercooling system including a plurality of separators for phase-separating mixed refrigerant and a de-icing unit for preventing freezing will be described in detail through the fourth to sixth embodiments.

### Fourth Embodiment

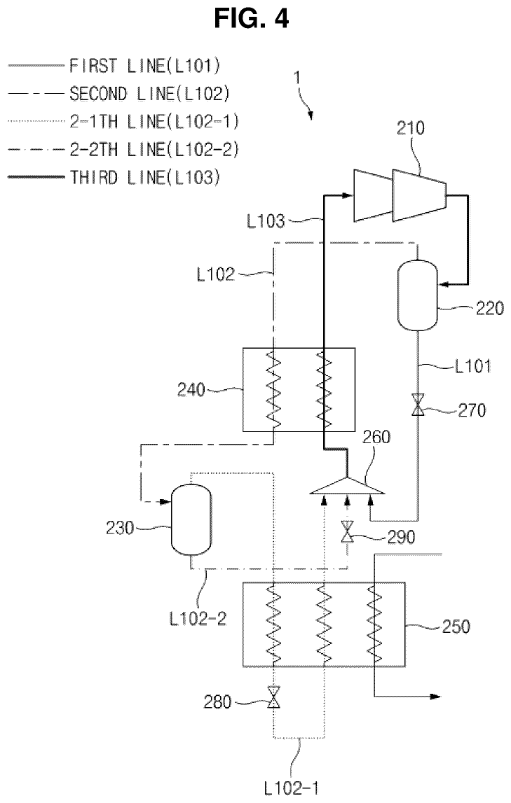

FIG. 4 is a diagram illustrating the liquefied gas supercooling system according to the fourth embodiment of the present disclosure.

Referring to FIG. 4, the liquefied gas supercooling system 1 according to the fourth embodiment of the present disclosure includes a compressor 210, a first separator 220, a second separator 230, a first heat exchanger 240, a second heat exchanger 250, a junction 260, a first pressure reducing valve 270, a second pressure reducing valve 280, a third pressure reducing valve 290, a first line L101, a second line L102, and a third line L103.

Hereinafter, each component, its role, and the flow of the process will be described.

For convenience, the first line L101, the second line L102, and the third line L103 are first defined.

The first line L101 refers to a path through which the liquid refrigerant separated from the first separator 220 passes through the first pressure reducing valve 270.

The second line L102 refers to a path through which the gaseous refrigerant separated from the first separator 220 passes through the first heat exchanger 240 and the second separator 230.

A 2-1th line L102-1 refers to a path through which the gaseous refrigerant separated from the second separator 230 passes through the second heat exchanger 250, the second pressure reducing valve 280, and the re-introduction into the second heat exchanger 250.

A 2-2th line L102-2 refers to a path through which the liquid refrigerant separated from the second separator 230 passes through the third pressure reducing valve 290.

The mixed refrigerant along the first line L101, the mixed refrigerant along the 2-1th line L102-1, and the mixed refrigerant along the 2-2th line L102-2 are joined and follow the third line L103.

The third line L103 refers to a path through which the mixed refrigerant joined from the first line L101, the 2-1th line L102-1, and the 2-2th line L102-2 passes through the first heat exchanger 240, the compressor 210, and the first separator 220. It may further include a junction 260 connected to the first line L101, the 2-1th line L102-1, and the 2-2th line L102-2 at the front end (at the inlet), and connected to the third line L103 at the rear end (at the outlet). The description below includes the junction 260, but is not limited thereto.

The compressor 210 compresses the mixed refrigerant at high pressure. Since the temperature of the mixed refrigerant increases during the compression process, a cooler (not shown in the drawing) may be installed at the rear end of the compressor 210 to lower the temperature. The cooler may lower the temperature of the mixed refrigerant to near the temperature of the seawater through heat exchange with the seawater. For example, this temperature may be 40° C. due to the seawater, but may vary depending on the temperature of the seawater or the performance of the cooler.

Installing a cooler at the rear end of the compressor is a common practice in compressor use, so it is not shown separately in the drawing.

The mixed refrigerant that has passed through the compressor 210 may enter the first separator 220 along the third line L103 and be phase-separated into the gaseous refrigerant and the liquid refrigerant. For example, among the components that make up the mixed refrigerant, light components such as C1 and C2 may be separated into the gaseous refrigerant, and heavy components such as C5 may be separated into the liquid refrigerant. In addition, as it passes through the compressor 210, oil contained in the mixed refrigerant may also be separated into the liquid refrigerant in the first separator 220. The reason for separating the mixed refrigerant into gaseous and liquid phases is that in the case of the liquid refrigerant, there is a risk of freezing when it exchanges heat with extremely low-temperature liquefied gas, so only the gaseous refrigerant is heat-exchanged with the liquefied gas.

The mixed refrigerant separated from the first separator 220, i.e., the liquid refrigerant and the gaseous refrigerant, may flow along the first line L101 and the second line L102, respectively. This will be described in detail below.

The liquid refrigerant separated from the first separator 220 enters the junction 260 through the first pressure reducing valve 270 along the first line L101, and joins the mixed refrigerant entering the junction 260 along the 2-1th line L102-1 described below and the mixed refrigerant entering the junction 260 along the 2-2th line L102-2.

The gaseous refrigerant separated from the first separator 220 enters the first heat exchanger 240 along the second line L102 and may be cooled by heat exchange with the mixed refrigerant entering the first heat exchanger 240 along the third line L103. In the first heat exchanger 240, heat exchange is performed between two refrigerant, that is, the gaseous refrigerant along the second line L102 and the mixed refrigerant along the third line L103. Thereafter, the gaseous refrigerant passing through the first heat exchanger 240 enters the second separator 230 and is separated again into the gaseous refrigerant and the liquid refrigerant. Even when phase separation has already occurred once in the first separator 220, since the separated gaseous refrigerant is cooled while passing through the first heat exchanger 240, the second separator 230 may contain not only the gaseous refrigerant but also the mixed refrigerant in the liquid phase.

The gaseous refrigerant separated from the second separator 230 enters the second heat exchanger 250 along the 2-1th line L102-1, and the mixed refrigerant that has passed through the second heat exchanger 250 is cooled by reducing the pressure in the second pressure reducing valve 280. Thereafter, it is re-introduced into the second heat exchanger 250 along the 2-1th line L102-1 and reaches the junction 260. During the cooling process in the second pressure reducing valve 280, the mixed refrigerant is cooled to a temperature of −170° C. or lower. This is because the temperature of the liquefied gas is usually about −160° C., and when it is supercooled, the temperature is lowered to −170° C. In addition, the temperature of the mixed refrigerant that has passed through the second pressure reducing valve 280 may rapidly decrease, causing freezing. To solve this problem, a de-icing unit is introduced, which will be described in the fifth embodiment of the present disclosure.

The mixed refrigerant that has passed through the second pressure reducing valve 280 is re-introduced into the second heat exchanger 250 and heat-exchanged with the liquefied gas to supercool the liquefied gas. Thereafter, the mixed refrigerant that has completed the heat exchange reaches the junction 260 and joins the two flows of mixed refrigerant that enter the junction 260 along the first line L101 and the 2-2th line L102-2. In this case, heat exchange between the mixed refrigerant and the liquefied gas that pass through the second heat exchanger 250 along the 2-1th line L102-1 may not be properly performed, and thus the temperature of the mixed refrigerant may not sufficiently increase. For example, the mixed refrigerant passing through the second heat exchanger 250 along the 2-1th line L102-1 should come out at approximately 0 degrees, but when heat exchange is not sufficiently performed, it may come out of the second heat exchanger 250 at a temperature lower than that, below zero. This may cause freezing of the mixed refrigerant flowing along the first line L101 and the 2-2th line L102-2 that are joined at the junction 260 and the oil contained in the mixed refrigerant. A de-icing unit has been introduced to solve this problem, which will be described in the fifth embodiment of the present disclosure. In the second heat exchanger 250, heat exchange is performed between three refrigerants, i.e. mixed refrigerant entering the second heat exchanger 250 along the 2-1th line L102-1, mixed refrigerant re-introduced through the second pressure reducing valve 280 along the 2-1th line L102-1, and liquefied gas.

The liquid refrigerant separated from the second separator 230 enters the junction 260 through the third pressure reducing valve 290 along the 2-2th line L102-2, and is joined with the mixed refrigerant entering the junction 260 along the 2-1th line L102-1 and the mixed refrigerant entering the junction 260 along the first line L101. In addition, the temperature of the mixed refrigerant that has passed through the third pressure reducing valve 290 may drop rapidly, causing freezing. A de-icing unit is introduced to solve this problem, which will be described in the sixth embodiment of the present disclosure.

The mixed refrigerant that has joined at the junction 260 enters the first heat exchanger 240 along the third line L103. The mixed refrigerant that has entered the first heat exchanger 240 along the third line L103 undergoes heat exchange with the gaseous refrigerant separated from the first separator 220, as described above. The mixed refrigerant that has completed the heat exchange enters the compressor 210 again along the third line L103.

### Fifth Embodiment

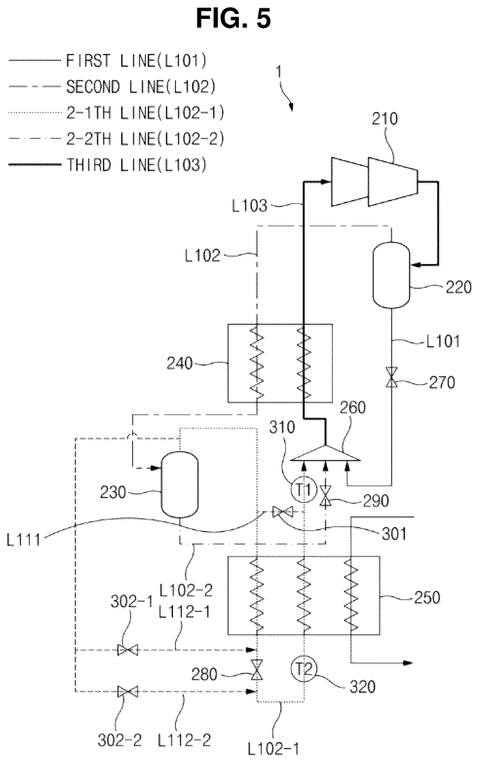

FIG. 5 is a diagram illustrating the liquefied gas supercooling system according to a fifth embodiment of the present disclosure.

The de-icing unit is a configuration that detects the temperature of a specific point and controls the temperature so that it does not fall below a certain level in order to prevent freezing of the mixed refrigerant.

Referring to FIG. 5, the liquefied gas supercooling system 1 according to the fifth embodiment of the present disclosure includes a first bypass valve 301 as a configuration for preventing freezing by controlling a first temperature T1 310, and includes a second-first bypass valve 302-1 and a second-second bypass valve 302-2 as a configuration for preventing freezing by controlling a second temperature T2 320. However, at least one of the second-first bypass valve 302-1 and the second-second bypass valve 302-2 in FIG. 5 may be omitted. Since other configurations are the same as in Example 4, their descriptions are omitted.

The first bypass valve 301 is configured to control the temperature (hereinafter referred to as ‘first temperature T1 310’) before the mixed refrigerant enters the junction 260 along the 2-1th line L102-1. The first bypass line L111 refers to a path that is branched from the 2-1th line L102-1 between the second separator 230 and the second heat exchanger 250 and is connected to the 2-1th line L102-1 between the second heat exchanger 250 and the junction 260. The first bypass valve 301 is provided on the first bypass line L111.

When the first temperature 310 is detected and the temperature is low enough to cause freezing of the mixed refrigerant, the high-temperature mixed refrigerant separated from the second separator 230 and flowing along the 2-1th line L102-1 is introduced into the front end of the junction 260 through the first bypass line L111 by controlling the first bypass valve 301, thereby increasing the temperature of the mixed refrigerant and preventing freezing.

The 2-first bypass valve 302-1 and the 2-second bypass valve 302-2 are configured to control the temperature (hereinafter referred to as ‘the second temperature T2 320’) of the mixed refrigerant after passing through the second pressure reducing valve 280 along the 2-1th line L102-1. The 2-1 bypass line L112-1 refers to a path that is branched from the 2-1th line L102-1 between the second separator 230 and the second heat exchanger 250 and connects to the 2-1th line L102-1 between the rear end of the second heat exchanger 250 and the second pressure reducing valve 280. The 2-2 bypass line L112-2 refers to a path that is branched from the 2-1th line L102-1 between the second separator 230 and the second heat exchanger 250 and connects to the 2-1th line L102-1 between the rear end of the second pressure reducing valve 280 and the second heat exchanger 250. The 2-1 bypass valve 302-1 is provided on the 2-1 bypass line L112-1, and the 2-2 bypass valve 302-2 is provided on the 2-2 bypass line L112-2.

When the second temperature 320 is detected and the temperature is low enough to cause freezing of the mixed refrigerant, the high-temperature mixed refrigerant separated from the second separator 230 and flowing along the 2-1th line L102-1 is introduced into the front end of the second pressure reducing valve 280 through the 2-1 bypass line L112-1 by controlling the 2-1 bypass valve 302-1, or the 2-2 bypass valve 302-2 is introduced into the rear end of the second pressure reducing valve 280 through the 2-2 bypass line L112-2 by controlling the 2-2 bypass valve 302-2, thereby increasing the temperature of the mixed refrigerant and preventing freezing.

By controlling the temperature, freezing of the mixed refrigerant may be prevented. By preventing freezing of the mixed refrigerant, failure of the liquefied gas supercooling system 1 may be prevented.

### Sixth Embodiment

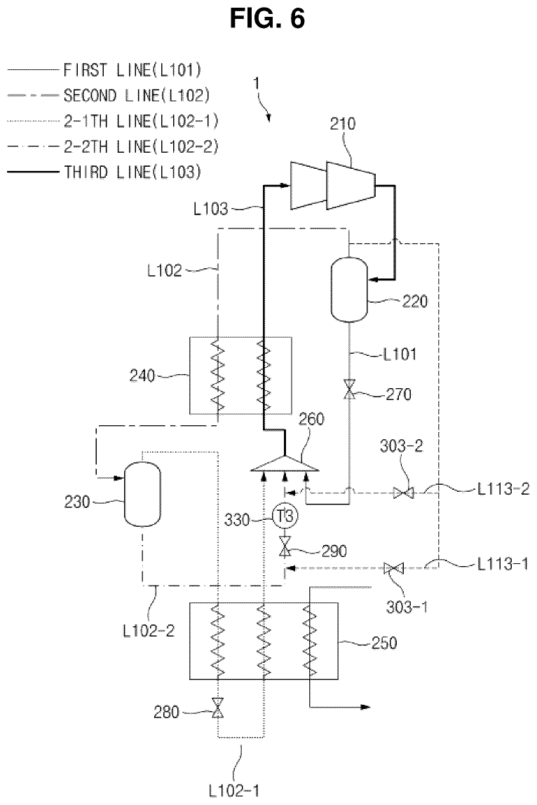

FIG. 6 is a diagram illustrating the liquefied gas supercooling system according to a sixth embodiment of the present disclosure.

Referring to FIG. 6, the liquefied gas supercooling system 1 according to the sixth embodiment of the present disclosure is configured to prevent freezing by controlling the third temperature T3 330, and includes a third-first bypass valve L303-1 and a third-second bypass valve L303-2. The other configurations are the same as in the fourth embodiment, so their description is omitted.

The third-first bypass valve 303-1 and the third-second bypass valve 303-2 are configured to control the temperature (hereinafter referred to as ‘third temperature T3 330’) after the mixed refrigerant passes through the third pressure reducing valve 290 along the second-second line L102-2. The 3-1 bypass line L113-1 refers to a path branched from the second line L102 between the first separator 220 and the first heat exchanger 240 and connected to the 2-2th line L102-2 between the second separator 230 and the third pressure reducing valve 290. The 3-1 bypass valve 303-1 is provided on the 3-1 bypass line L113-1. The 3-2 bypass line L113-2 refers to a path branched from the second line L102 between the first separator 220 and the first heat exchanger 240 and connected to the 2-2th line L102-2 between the third pressure reducing valve 290 and the junction 260. The 3-2 bypass valve 303-2 is provided on the 3-2 bypass line L113-2.

When the third temperature 330 is detected and the temperature is low enough to cause freezing of the mixed refrigerant, the high-temperature mixed refrigerant separated from the first separator 220 and flowing along the second line L102 is introduced into the front end of the third pressure reducing valve 290 through the 3-1 bypass line L113-1 by controlling the 3-1 bypass valve 303-1, or the 3-2 bypass valve 303-2 is introduced into the rear end of the third pressure reducing valve 290 through the 3-2 bypass line L113-2 by controlling the 3-2 bypass valve 303-2, thereby increasing the temperature of the mixed refrigerant and preventing freezing.

By preventing freezing of the mixed refrigerant, failure of the liquefied gas supercooling system 1 may be prevented.

Hereinafter, the liquefied gas supercooling system that does not include a separator for separating mixed refrigerant or includes a single separator and a de-icing unit that prevents freezing will be described in detail through seventh to fifteenth embodiments.

### Seventh Embodiment

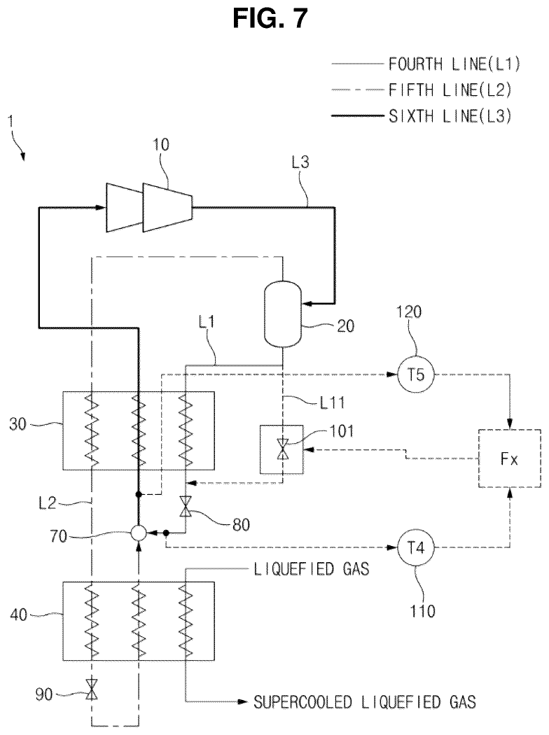

FIG. 7 is a diagram illustrating the liquefied gas supercooling system according to a seventh embodiment of the present disclosure.

Referring to FIG. 7, the liquefied gas supercooling system 1 according to the seventh embodiment of the present disclosure includes a compressor 10, a separator 20, a first heat exchanger 30, a second heat exchanger 40, a junction 70, a first pressure reducing valve 80, a second pressure reducing valve 90, a fourth bypass valve 101, a fourth line L1, a fifth line L2, and a sixth line L3.

Hereinafter, each component, its role, and the flow of the process will be described.

For convenience, the fourth line L1, the fifth line L2, and the sixth line L3 are first defined.

The fourth line L1 refers to the path through which the liquid refrigerant separated from the separator 20 passes through the first heat exchanger 30 and the first pressure reducing valve 80.

The fifth line L2 refers to the path through which the gaseous refrigerant separated from the separator 20 passes through the first heat exchanger 30, the second heat exchanger 40, the second pressure reducing valve 90, and the second heat exchanger 40. The refrigerant along the fourth line L1 and the refrigerant along the fifth line L2 are joined and follow the sixth line L3.

The sixth line L3 refers to a path through which mixed refrigerant joined from the fourth line L1 and the fifth line L2 passes through the first heat exchanger 30, the compressor 10, and the separator 20.

It may further include a junction 70 connected to the fourth line L1 and the fifth line L2 at the front end (at the inlet) and connected to the sixth line L3 at the rear end (at the outlet). The description below includes the junction 70, but is not limited thereto.

The compressor 10 compresses the mixed refrigerant at high pressure. The mixed refrigerant that has passed through the compressor 10 may enter the separator 20 along the sixth line L3 and be phase-separated into the gaseous refrigerant and the liquid refrigerant. For example, among the components of the mixed refrigerant, light components such as C1 and C2 may be separated into the gaseous refrigerant, and heavy components such as C5 may be separated into the liquid refrigerant. The reason for separating the mixed refrigerant into gaseous and liquid phases is that, in the case of the liquid refrigerant, there is a risk of freezing when heat exchanged with an extremely low-temperature liquefied gas, so only the gaseous refrigerant undergoes heat exchange with the liquefied gas.

The mixed refrigerant separated from the separator 20, i.e., the liquid refrigerant and the gaseous refrigerant, may flow along the fourth line L1 and the fifth line L2, respectively. This will be described in detail below.

The liquid refrigerant separated from the separator 20 enters the first heat exchanger 30 along the fourth line L1 and may be cooled by heat exchange with the mixed refrigerant entering the first heat exchanger 30 along the sixth line L3. In the first heat exchanger 30, heat exchange is performed between three flows of refrigerant, namely, the liquid refrigerant along the fourth line L1, the gaseous refrigerant along the fifth line L2, and the mixed refrigerant along the sixth line L3. Thereafter, the liquid refrigerant passing through the first heat exchanger 30 is cooled by depressurizing in the first pressure reducing valve 80.

In a typical process, the liquid refrigerant enters the pressure reducing valve directly without passing through the heat exchanger. However, in the present disclosure, the liquid refrigerant is first cooled in the first heat exchanger 30 before passing through the first pressure reducing valve 80, so that the liquid refrigerant at a relatively lower temperature may enter the first pressure reducing valve 80. Since the liquid refrigerant is first cooled in the first heat exchanger 30 before passing through the first pressure reducing valve 80, there is an effect of increasing the cooling efficiency of the first pressure reducing valve 80. However, since a cooling process is added before the pressure reducing valve, the temperature of the liquid refrigerant passing through the pressure reducing valve may drop rapidly, causing freezing. To solve this problem, a de-icing unit was introduced, which will be described later.

The liquid refrigerant that has passed through the first pressure reducing valve 80 reaches the junction 70 and is joined with the refrigerant that enters the junction 70 along the fifth line L2. The refrigerant that enters the junction 70 along the fifth line L2 from the separator 20 may be the gaseous refrigerant, or may include a mixed refrigerant that has been partially converted to a liquid phase while passing through the second heat exchanger 40 or the second pressure reducing valve 90 in addition to the gaseous refrigerant.

The gaseous refrigerant separated from the separator 20 enters the first heat exchanger 30 along the fifth line L2 and is cooled by heat exchange with the mixed refrigerant that enters the first heat exchanger 30 along the sixth line L3. Since the gaseous refrigerant may change phase as it passes through the first heat exchanger 30, the second heat exchanger 40, the second pressure reducing valve 90, etc., to avoid confusion, the term mixed refrigerant is not distinguished between the gaseous refrigerant and the liquid refrigerant, and is used unified hereafter. Thereafter, the mixed refrigerant re-introduced into the second heat exchanger 40 along the fifth line L2, and the mixed refrigerant that has passed through the second heat exchanger 40 is cooled by reducing pressure in the second pressure reducing valve 90. Thereafter, it is re-introduced into the second heat exchanger 40 along the fifth line L2 and reaches the junction 70. During the cooling process in the second pressure reducing valve 90, the mixed refrigerant is cooled to a temperature of −170° C. or lower. This is because the temperature of the liquefied gas is usually around −160° C., and when it is supercooled, the temperature is lowered to −170° C. In addition, here, the temperature of the mixed refrigerant that has passed through the second pressure reducing valve 90 may drop rapidly, causing freezing. A de-icing unit was introduced to solve this problem, which will be explained later.

The mixed refrigerant that has passed through the second pressure reducing valve 90 is re-introduced into the second heat exchanger 40 and heat-exchanged with the liquefied gas to supercool the liquefied gas. Thereafter, the mixed refrigerant that has completed the heat exchange reaches the junction 70 and is joined with the mixed refrigerant that has entered the junction 70 along the fourth line L1. In the second heat exchanger 40, heat exchange is performed between three flows of refrigerant, i.e. the mixed refrigerant that has passed through the first heat exchanger 30 along the fifth line L2, the mixed refrigerant that has been re-introduced through the second pressure reducing valve 90 along the fifth line L2, and the liquefied gas.

The mixed refrigerant that has been joined at the junction 70 enters the first heat exchanger 30 along the sixth line L3. In this case, since the mixed refrigerant coming in along the fourth line L1 may freeze when it meets the mixed refrigerant coming in along the low-temperature fifth line L2, a de-icing unit is introduced to solve this problem, which will be described later. The de-icing unit may prevent freezing of the refrigerant and the oil.

As described above, the mixed refrigerant coming in through the sixth line L3 to the first heat exchanger 30 undergoes heat exchange with the mixed refrigerant coming in through the fourth line L1 to the first heat exchanger 30 and the mixed refrigerant coming in through the fifth line L2 to the first heat exchanger 30. The mixed refrigerant that has completed the heat exchange re-enters the compressor 10 through the sixth line L3.

The de-icing unit is described below.

The de-icing unit is configured to detect the temperature of a specific point and control the temperature so that it does not fall below a certain level in order to prevent freezing of mixed refrigerant and oil.

Referring to FIG. 7, Embodiment 1 of the present disclosure is a de-icing unit, which includes a fourth bypass valve 101.

The fourth bypass valve 101 is configured to control the temperature at the rear end of the first pressure reducing valve 80 (hereinafter referred to as ‘fourth temperature T4 110’) and the temperature between the junction 70 and the first heat exchanger 30 (hereinafter referred to as ‘fifth temperature T5 120’). The fourth bypass valve 101 is provided on the fourth bypass line L11 branched from the fourth line L1 between the separator 20 and the first heat exchanger 30 and connected to the fourth line L1 between the first heat exchanger 30 and the first pressure reducing valve 80.

The fourth temperature 110 and the fifth temperature 120 are detected, and when the lower temperature among the temperatures is low enough to cause freezing of the mixed refrigerant, the high-temperature mixed refrigerant separated from the separator 20 and flowing along the fourth line L1 is controlled by the fourth bypass valve 101 to be introduced into the front end of the first pressure reducing valve 31 through the fourth bypass line L11 to increase the temperature of the mixed refrigerant and prevent freezing.

The example in which the high-temperature mixed refrigerant flows into the front end of the first pressure reducing valve 80 through the fourth bypass line L11 is explained, but it is not limited thereto. For example, the high-temperature mixed refrigerant may flow into the rear end of the first pressure reducing valve 80 through the fourth bypass line L11.

By preventing freezing of the mixed refrigerant, the failure of the liquefied gas supercooling system 1 may be prevented.

### Eighth and Ninth Embodiments

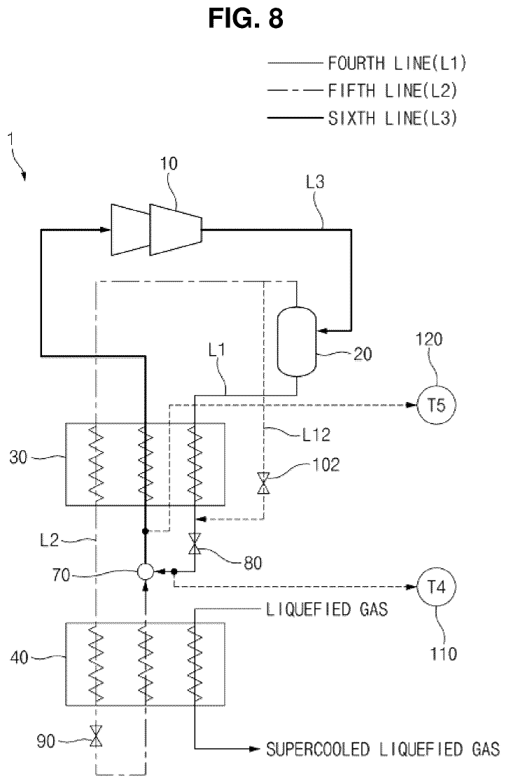

FIG. 8 is a diagram illustrating the liquefied gas supercooling system 1 according to an eighth embodiment of the present disclosure.

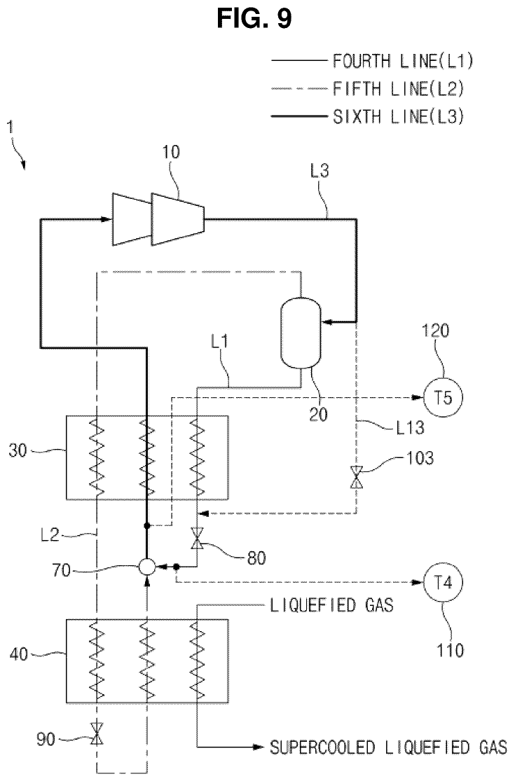

FIG. 9 is a diagram illustrating the liquefied gas supercooling system 1 according to a ninth embodiment of the present disclosure.

The seventh embodiment includes a fourth bypass line L11 as a configuration for controlling the fourth temperature 110 and the fifth temperature 120, while the eighth and ninth embodiments include a fifth bypass line L12 and a sixth bypass line L13 as a configuration for controlling the fourth temperature 110 and the fifth temperature 120.

Referring to FIG. 8, the liquefied gas supercooling system 1 according to the eighth embodiment of the present disclosure includes a fifth bypass line L12 as a configuration for controlling the fourth temperature 110 and the fifth temperature 120 to prevent freezing. Since other configurations are the same as in the first embodiment, their descriptions are omitted.

The fifth bypass valve 102 is provided on the fifth bypass line L12 which is branched from the fifth line L2 between the separator 20 and the first heat exchanger 30 and is connected to the fourth line L1 between the first heat exchanger 30 and the first pressure reducing valve 80.

For another example, the fifth bypass valve 102 is provided on the fifth bypass line L12 which is branched from a part of the fourth line L1 between the separator 20 and the first heat exchanger 30 and is connected to another part of the fourth line L1 between the first heat exchanger 30 and the first pressure reducing valve 80.

The fourth temperature 110 and the fifth temperature 120 are detected, and when the lower temperature among the temperatures is low enough to cause freezing of the mixed refrigerant, the high-temperature mixed refrigerant separated from the separator 20 and flowing along the fifth line L2 is introduced into the front end of the first pressure reducing valve 80 through the fifth bypass line L12 by controlling the fifth bypass valve 102, thereby increasing the temperature of the mixed refrigerant and preventing freezing.

The example in which the high-temperature mixed refrigerant is introduced into the front end of the first pressure reducing valve 80 through the fifth bypass line L12 is described, but is not limited thereto. For example, the high-temperature mixed refrigerant may be introduced into the rear end of the first pressure reducing valve 80 through the fifth bypass line L12.

Referring to FIG. 9, the liquefied gas supercooling system 1 according to the ninth embodiment of the present disclosure includes a sixth bypass valve 103 as a configuration for preventing freezing by controlling the fourth temperature 110 and the fifth temperature 120. Since the other configurations are the same as FIG. 7, their descriptions are omitted.

The sixth bypass valve 103 is provided on the sixth bypass line L13 branched from the sixth line L3 between the compressor 10 and the separator 20 and connected to the fourth line L1 between the first heat exchanger 30 and the first pressure reducing valve 80. For example, the sixth bypass line L13 may be connected to a part of the fourth line L1 that passes the first heat exchanger 30 in front end of the first pressure reducing valve 80.

The fourth temperature 110 and the fifth temperature 120 are detected, and when the lower temperature among the temperatures is low enough to cause freezing of the mixed refrigerant, the high-temperature mixed refrigerant from the compressor 10 is introduced into the front end of the first pressure reducing valve 80 through the sixth bypass line L13 by controlling the sixth bypass valve 103, thereby increasing the temperature of the mixed refrigerant and preventing freezing.

The example in which the high-temperature mixed refrigerant is introduced into the front end of the first pressure reducing valve 80 through the sixth bypass line L13 is described, but is not limited thereto. For example, the high-temperature mixed refrigerant may be introduced into the rear end of the first pressure reducing valve 80 through the sixth bypass line L13.

By controlling the temperature, freezing of the mixed refrigerant may be prevented. By preventing freezing of mixed refrigerant, failure of the liquefied gas supercooling system 1 may be prevented.

### Tenth Embodiment

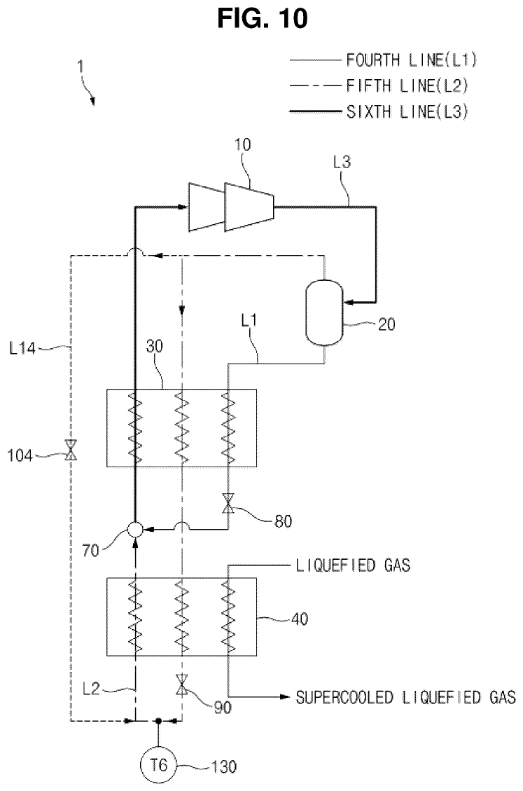

FIG. 10 is a diagram illustrating the liquefied gas supercooling system 1 according to a tenth embodiment of the present disclosure.

Referring to FIG. 10, the liquefied gas supercooling system 1 according to the tenth embodiment of the present disclosure includes a seventh bypass valve 104 as a configuration for preventing freezing by controlling the sixth temperature 130. Since other configurations are the same as those of the first embodiment, description thereof will be omitted.

The seventh bypass valve 104 is a configuration for controlling the temperature (hereinafter referred to as ‘sixth temperature 130’) before re-introduction into the second heat exchanger 40 at the rear end of the second pressure reducing valve 90 along the fifth line L2. The seventh bypass valve 104 is provided on the seventh bypass line L14 branched from the fifth line L2 between the separator 20 and the first heat exchanger 30 and connected to the fifth line L2 between the second pressure reducing valve 90 and the second heat exchanger 40.

When the sixth temperature 130 is detected and the temperature is low enough to cause freezing of the mixed refrigerant, the high-temperature mixed refrigerant separated from the separator 20 and flowing along the fifth line L2 is controlled by the seventh bypass valve 104 to be introduced into the rear end of the second pressure reducing valve 90 through the seventh bypass line L14 to increase the temperature of the mixed refrigerant and prevent freezing.

The seventh bypass line L14 may be branched from the fifth line L2 and connected to a portion of the fifth line L2 that has first passed through the second heat exchanger 40. The seventh bypass line L14 may be branched from the fifth line L2 and connected to a portion of the fifth line L2 that has first passed through the second heat exchanger 40 and then after the second pressure reducing valve 90.

The example in which the high-temperature mixed refrigerant flows into the rear end of the second pressure reducing valve 90 through the seventh bypass line L14 is described, but is not limited thereto. For example, the high-temperature mixed refrigerant may be introduced into the front end of the second pressure reducing valve 90 through the seventh bypass line L14.

By controlling the temperature, freezing of the mixed refrigerant may be prevented. By preventing freezing of the mixed refrigerant, failure of the liquefied gas supercooling system 1 may be prevented.

### Eleventh Embodiment

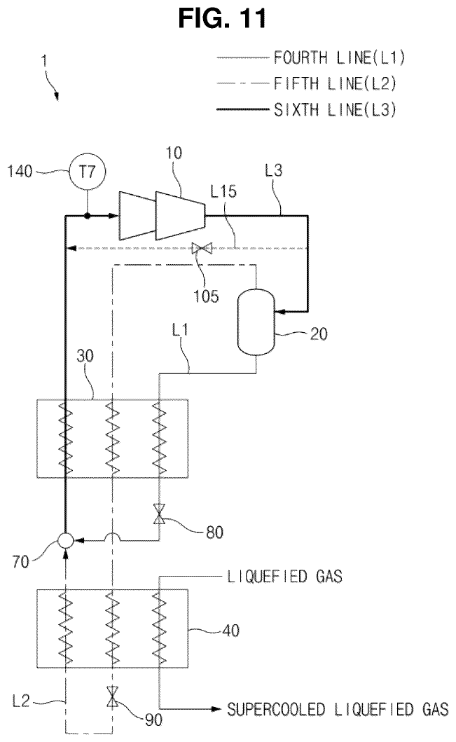

FIG. 11 is a diagram illustrating the liquefied gas supercooling system 1 according to an eleventh embodiment of the present disclosure.

Referring to FIG. 11, the liquefied gas supercooling system 1 according to the eleventh embodiment of the present disclosure includes an eighth bypass valve 105 as a configuration for preventing freezing by controlling the seventh temperature 140. Since other configurations are the same as in the first embodiment, their description is omitted.

The eighth bypass valve 105 is a configuration for controlling the temperature (hereinafter referred to as the ‘seventh temperature 140’) of the front end of the compressor 10 along the sixth line L3. The eighth bypass valve 105 is provided on the eighth bypass line L15 branched from the sixth line L3 between the compressor 10 and the separator 20 and connected to the sixth line L3 between the first heat exchanger 30 and the compressor 10.

The eighth bypass line L15 may be branched from the rear end of the compressor 10 on the sixth line L3 and connected to the front end of the compressor 10.

When the seventh temperature 140 is detected and the temperature is low enough to cause droplets to form at the inlet of the compressor 10, the high-temperature mixed refrigerant compressed in the compressor 10 is introduced into the front end of the compressor 10 through the eighth bypass line L15 by controlling the eighth bypass valve 105 to increase the temperature of the mixed refrigerant and prevent droplet formation.

By preventing droplet formation, the failure of the liquefied gas supercooling system 1 may be prevented.

### Twelfth and Thirteenth Embodiments

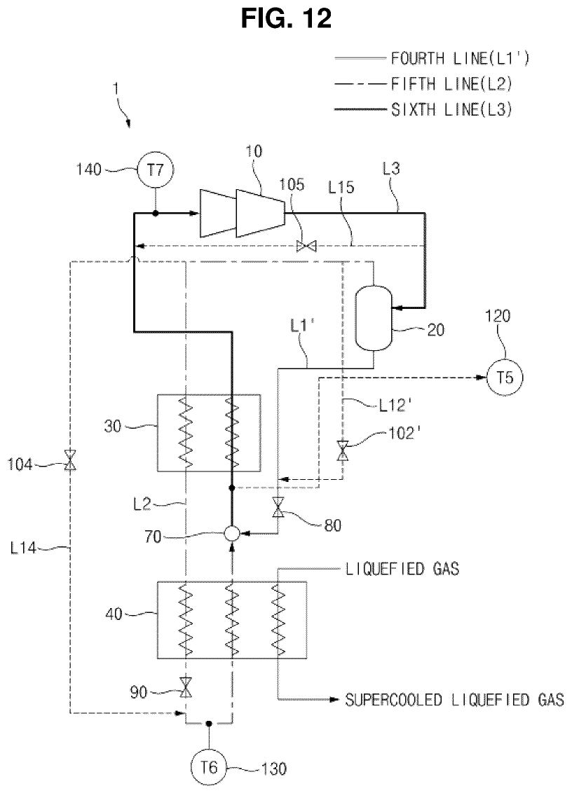

FIG. 12 is a diagram illustrating the liquefied gas supercooling system 1 according to a twelfth embodiment of the present disclosure.

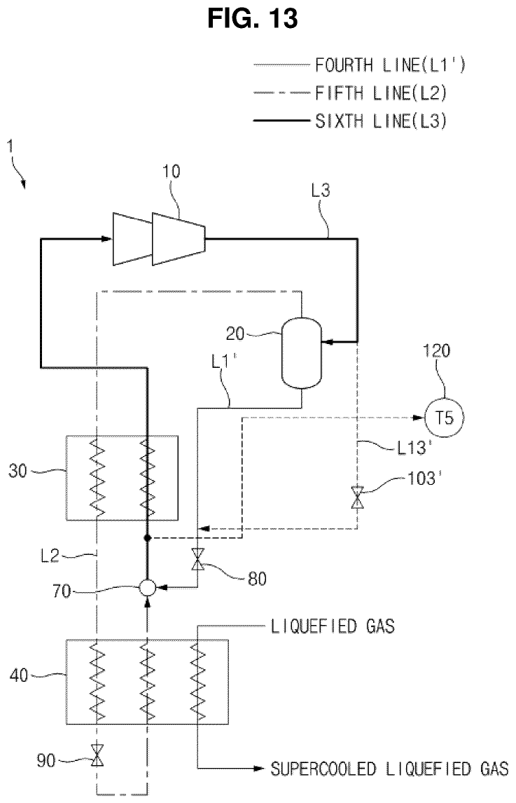

FIG. 13 is a diagram illustrating the liquefied gas supercooling system 1 according to the thirteenth embodiment of the present disclosure.

Referring to FIGS. 12 and 13, the liquefied gas supercooling system 1 according to the twelfth and thirteenth embodiments of the present disclosure has a difference from the liquefied gas supercooling system 1 according to the seventh to eleventh embodiments of the present disclosure in that the liquid refrigerant separated from the separator 20 is cooled by being depressurized directly in the first pressure reducing valve 80 without passing through the first heat exchanger 30. That is, the fourth line L1′ according to the twelfth and thirteenth embodiments refers to a path through which the liquid refrigerant separated from the separator 20 passes through the first pressure reducing valve 80 and the junction 70. The fifth line L2 and the sixth line L3 are the same as the first to eleventh embodiments described above.

In addition, at least one of the seventh bypass valve 104 and the eighth bypass valve 105 in FIG. 12 may be omitted.

Since the liquid refrigerant is cooled without passing through the first heat exchanger 30, there is no concern about freezing occurring at the rear end of the first pressure reducing valve 80, so there is no need to control the fourth temperature 110, and only the fifth temperature 120 needs to be controlled.

According to the above difference, some of the configurations of the de-icing unit that controls the fifth temperature 120 also change. However, the configuration of the de-icing unit that controls the sixth temperature 130 and the seventh temperature 140 is the same.

Referring to FIG. 12, the fifth bypass valve 102′ is included as a configuration for preventing freezing by controlling the fifth temperature 120. The fifth bypass valve 102′ is provided on the fifth bypass line L12′ branched from the fifth line L2 between the separator 20 and the first heat exchanger 30 and connected to the fourth line L1 between the separator 20 and the first heat exchanger 30.

For another example, the fifth bypass valve 102′ is provided on the fifth bypass line L12′ branched from a part of the fourth line L1′ in front end of the first pressure reducing valve 80 and connected to another part of the fourth line L1′ in the rear of the first pressure reducing valve 80.

When the fifth temperature 120 is detected and the temperature is low enough to cause freezing of the mixed refrigerant, the high-temperature mixed refrigerant separated from the separator 20 is introduced into the front end of the first pressure reducing valve 80 through the fifth bypass line L12′ by controlling the fifth bypass valve 102′, thereby increasing the temperature of the mixed refrigerant and preventing freezing of the mixed refrigerant and oil.

The example in which the high-temperature mixed refrigerant is introduced into the front end of the first pressure reducing valve 80 through the fifth bypass line L12′ is described, but is not limited thereto. For example, the high-temperature mixed refrigerant may be introduced into the rear end of the first pressure reducing valve 80 through the fifth bypass line L12′.

The fifth bypass line L12′ has been described with reference to the examples as being connected to the fourth line L1′ to prevent freezing of the mixed refrigerant, but it is not limited thereto. For example, the fifth bypass line L12′ may be omitted.

The seventh bypass line L14 and the seventh bypass valve 104 refer to the tenth embodiment, and the eighth bypass line L15 and the eighth bypass valve 105 refer to the eleventh embodiment. For another example, the liquefied gas supercooling system 1 of FIG. 12 may omit the seventh bypass line L14 and the seventh bypass valve 104, or may omit the eighth bypass line L15 and the eighth bypass valve 105.

Although not shown in FIG. 12, the twelfth embodiment may further include the sixth bypass line L13′ and the sixth bypass valve 103′ of the thirteenth embodiment.

Referring to FIG. 13, the sixth bypass valve 103′ is included as a configuration for controlling the fifth temperature 120 to prevent freezing. The sixth bypass valve 103′ is provided on the sixth bypass line L13′ branched from the sixth line L3 between the compressor 10 and the separator 20 and connected to the fourth line L1 between the separator 20 and the first heat exchanger 30.

When the fifth temperature 120 is detected and the temperature is low enough to cause freezing of the mixed refrigerant, the high-temperature mixed refrigerant from the compressor 10 is introduced into the front end of the first pressure reducing valve 80 through the sixth bypass line L13′ by controlling the sixth bypass valve 103′ to increase the temperature of the mixed refrigerant and prevent freezing. By preventing freezing of the mixed refrigerant, the failure of the liquefied gas supercooling system 1 may be prevented.

### Fourteenth Embodiment

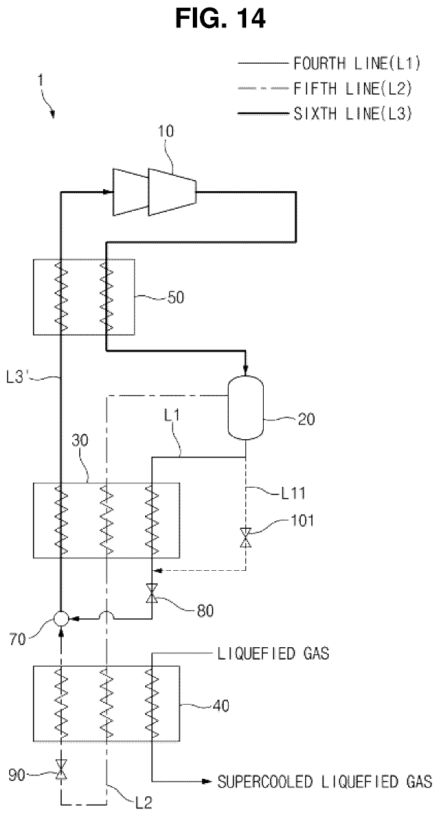

FIG. 14 is a diagram illustrating the liquefied gas supercooling system 1 according to a fourteenth embodiment of the present disclosure.

Referring to FIG. 14, the liquefied gas supercooling system 1 according to the fourteenth embodiment of the present disclosure additionally has a third heat exchanger 50 compared to the liquefied gas supercooling system 1 according to the seventh embodiment. However, without being limited to this, the third heat exchanger 50 may be added to the eighth to thirteenth embodiments as well as the seventh embodiment.

The sixth line L3′ according to the fourteenth embodiment refers to the path through which the mixed refrigerant joined at the junction 70 passes through the first heat exchanger 30, the third heat exchanger 50, the compressor 10, the re-introduction to the third heat exchanger 50, and the separator 20. The fourth line L1 and the fifth line L2 are the same as the seventh to eleventh embodiments described above.

The third heat exchanger 50 is disposed so that the mixed refrigerant passing through the first heat exchanger 30 along the sixth line L3′ and the mixed refrigerant passing through the compressor 10 along the sixth line L3′ exchange heat. The mixed refrigerant that has undergone heat exchange in the third heat exchanger 50 may be phase-separated by entering the separator 20.

Specifically, before the high-temperature mixed refrigerant that has passed through the compressor 10 in the third heat exchanger 50 enters the separator 20 and is phase-separated, it is cooled by heat exchange with the relatively low-temperature mixed refrigerant that has passed through the first heat exchanger 30 along the sixth line L3′. By cooling the mixed refrigerant once before separation, the phase separation may occur more effectively. For example, the mixed refrigerant that has been cooled in the third heat exchanger 50 before entering the separator 20 may be phase-separated from the separator 20 more effectively than the mixed refrigerant that has not passed through the third heat exchanger 50.

### Fifteenth Embodiment

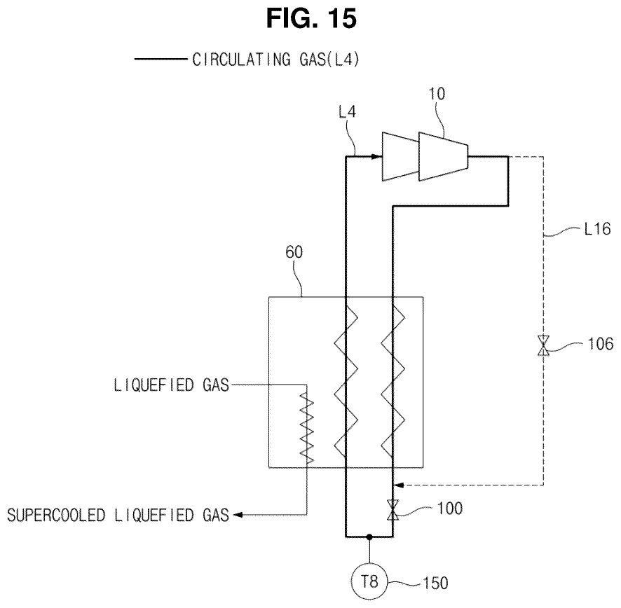

FIG. 15 is a diagram illustrating the liquefied gas supercooling system 1 according to a fifteenth embodiment of the present disclosure.

Referring to FIG. 15, the liquefied gas supercooling system 1 according to the fifteenth embodiment of the present disclosure includes a compressor 10, a heat exchanger 60, a pressure reducing valve 100, a ninth bypass valve 106, and a circulating line L4.

The circulating line L4 refers to a path through which mixed refrigerant compressed in the compressor 10 returns to the compressor 10 via the heat exchanger 60, the pressure reducing valve 100, and the re-introduction into the heat exchanger 60.

The mixed refrigerant compressed in the compressor 10 enters the heat exchanger 60 along the circulating line L4, and is cooled by heat exchange with the mixed refrigerant re-introduced into the heat exchanger 60 via the pressure reducing valve 100. The mixed refrigerant that is primarily cooled is decompressed in the pressure reducing valve 100 and cooled, and then re-introduced into the heat exchanger 60. The re-introduced mixed refrigerant supercools the liquefied gas through heat exchange with the liquefied gas and returns to the compressor 10 along the circulating line L4.

Since phase separation does not occur, the mixed refrigerant goes to an extremely low temperature during the cooling process while containing heavy components such as C5, and during this process, a problem of C5 freezing may occur. Therefore, a de-icing unit is required to control the temperature (hereinafter referred to as the ‘eighth temperature 150’) before re-introducing it into the heat exchanger 60 at the rear of the pressure reducing valve 100.

The ninth bypass valve 106 is configured to control the eighth temperature 150. The ninth bypass valve 106 is provided on the ninth bypass line L16 branched from the circulating line L4 between the compressor 10 and the heat exchanger 60 and connected to the circulating line L4 between the pressure reducing valve 100 and the heat exchanger 60.

When the eighth temperature 150 is detected and the temperature is low enough to cause freezing of the mixed refrigerant, the high-temperature mixed refrigerant from the compressor 10 is controlled by the ninth bypass valve 106 to be introduced into the front end of the pressure reducing valve 100 through the ninth bypass line L16 to increase the temperature of the mixed refrigerant and prevent freezing.

By preventing freezing of the mixed refrigerant, the failure of the liquefied gas supercooling system 1 may be prevented.

The liquefied gas supercooling system 1 according to the first to fifteenth embodiments of the present disclosure may include pentane as its component.

The above description is merely examples of the technical spirit of the present disclosure, and may be variously modified and altered by those skilled in the art without departing from the essential characteristics of the present disclosure. Accordingly, the embodiments disclosed in the present disclosure are not to limit the technical spirit of the present disclosure, but are to describe the technical spirit of the present disclosure. The scope of technical spirit of the present disclosure is not limited to these embodiments. The scope of protection of the present disclosure should be interpreted by the following claims and it should be interpreted that all technical spirits equivalent to the following claims fall within the scope of the present disclosure.

What is claimed is:

1. A liquefied gas supercooling system using a mixed refrigerant, comprising:
a compressor that compresses the mixed refrigerant;
a first separator that is provided at a rear end of the compressor to phase-separate the mixed refrigerant into a gaseous refrigerant and a liquid refrigerant;
a first line through which the liquid refrigerant separated from the first separator flows through a first pressure reducing valve;
a second line through which the gaseous refrigerant separated from the first separator flows through a first heat exchanger and a second separator;
a second separator that is provided at a rear end of the first heat exchanger to phase-separate the mixed refrigerant separated from the first separator and passing through the second line into the gaseous refrigerant and the liquid refrigerant;
a 2-1th line through which the gaseous refrigerant separated from the second separator flows through a second heat exchanger, a second pressure reducing valve, and a re-introduction into the second heat exchanger;
a 2-2th line through which the liquid refrigerant separated from the second separator flows through a third pressure reducing valve; and
a third line through which the mixed refrigerant joined from the first line, the 2-1th line, and the 2-2th line flows through the first heat exchanger, the compressor, and the first separator,
wherein, in the first heat exchanger, the gaseous refrigerant separated from the first separator and flowing along the second line, and the mixed refrigerant flowing along the third line are heat-exchanged,
in the second heat exchanger, the gaseous refrigerant separated from the second separator along the 2-1th line, the mixed refrigerant passing through the second pressure reducing valve along the 2-1th line, and the liquefied gas are heat-exchanged, and
the liquefied gas is supercooled by the heat exchange in the second heat exchanger.

2. The liquefied gas supercooling system of claim 1, wherein, in the first pressure reducing valve, the liquid refrigerant separated from the first separator and flowing along the first line is depressurized to lower its temperature,
in the second pressure reducing valve, the mixed refrigerant passing through the second heat exchanger along the 2-1th line is depressurized to lower its temperature, and
in the third pressure reducing valve, the liquid refrigerant separated from the second separator and flowing along the 2-2th line is depressurized to lower its temperature.

3. The liquefied gas supercooling system of claim 1, further comprising:
a junction connected to the first line, the 2-1th line, and the 2-2th line at a front end, and connected to the third line at a rear end,
wherein the mixed refrigerant joined at the junction flows along the third line and passes through the first heat exchanger, and
the liquid refrigerant that passes through the first pressure reducing valve, the mixed refrigerant that passes through the second heat exchanger via the second pressure reducing valve, and the liquid refrigerant that passes through the third pressure reducing valve are joined at the junction.

4. The liquefied gas supercooling system of claim 1, further comprising:
a junction connected to the first line, the 2-1th line, and the 2-2th line at a front end, and connected to the third line at a rear end;
a bypass line that is branched from at least one of the second line and the 2-1th line; and
a de-icing unit that controls the temperature of the mixed refrigerant on the 2-1th line or the 2-2th line by controlling an inflow of a relatively high-temperature mixed refrigerant through a bypass valve provided in the bypass line.

5. The liquefied gas supercooling system of claim 4, wherein the de-icing unit controls a first temperature of the mixed refrigerant before entering the junction along the 2-1th line.

6. A liquefied gas supercooling system using a mixed refrigerant, comprising:
a compressor that compresses the mixed refrigerant;
a separator that is provided at a rear end of the compressor to phase-separate the mixed refrigerant into a gaseous refrigerant and a liquid refrigerant;
a fourth line through which the liquid refrigerant separated from the separator flows through a first pressure reducing valve;
a fifth line through which the gaseous refrigerant separated from the separator flows through a first heat exchanger, a second heat exchanger, a second pressure reducing valve, and the re-introduction into the second heat exchanger;
a sixth line through which the mixed refrigerant joined from the fourth line and the fifth line flows through the first heat exchanger, the compressor, and the separator; and
a de-icing unit that has a bypass line branched from at least one of the fifth line and the sixth line, and controls an inflow of a relatively high-temperature mixed refrigerant through a bypass valve provided in the bypass line and controls a temperature of the mixed refrigerant on the fifth line or the sixth line,
wherein, in the first heat exchanger, the gaseous refrigerant separated from the separator and flowing along the fifth line, and the mixed refrigerant flowing along the sixth line are heat-exchanged,
in the second heat exchanger, the mixed refrigerant passing through the first heat exchanger along the fifth line, the mixed refrigerant passing through the second pressure reducing valve along the fifth line, and the liquefied gas are heat-exchanged, and
the liquefied gas is supercooled by the heat exchange in the second heat exchanger.

7. The liquefied gas supercooling system of claim 6, wherein the liquid refrigerant separated from the separator and flowing along the fourth line is depressurized in the first pressure reducing valve to lower its temperature, and
the mixed refrigerant passing through the second heat exchanger along the fifth line is depressurized in the second pressure reducing valve to lower its temperature.

8. The liquefied gas supercooling system of claim 6, further comprising:
a junction connected to the fourth line and the fifth line at a front end and connected to the sixth line at a rear end,
wherein the de-icing unit controls a fifth temperature of the mixed refrigerant before entering the first heat exchanger along the sixth line.

9. The liquefied gas supercooling system of claim 8, wherein the de-icing unit includes a fifth bypass valve,
the fifth bypass valve is provided on a fifth bypass line branched from at least one of the fourth line, the fifth line, and the sixth line and connected to the fourth line at the front end of the first pressure reducing valve or the rear end of the first pressure reducing valve.

10. The liquefied gas supercooling system of claim 6, further comprising:
a junction connected to the fourth line and the fifth line at a front end and connected to the sixth line at a rear end,
wherein the de-icing unit controls a sixth temperature of the mixed refrigerant through the second pressure reducing valve along the fifth line.

11. The liquefied gas supercooling system of claim 10, wherein the de-icing unit includes a seventh bypass valve, and
the seventh bypass valve is provided on a seventh bypass line branched from the fifth line between the separator and the first heat exchanger and connected to the fifth line at a front end of the second pressure reducing valve or a rear end of the second pressure reducing valve.

12. The liquefied gas supercooling system of claim 6, further comprising:
a junction connected to the fourth line and the fifth line at a front end and connected to the sixth line at a rear end,
wherein the de-icing unit controls a seventh temperature of the mixed refrigerant that enters the compressor along the sixth line.

13. The liquefied gas supercooling system of claim 12, wherein the de-icing unit includes an eighth bypass valve, and
the eighth bypass valve is provided on an eighth bypass line branched from the sixth line between the compressor and the separator and connected to the sixth line between the first heat exchanger and the compressor.

14. The liquefied gas supercooling system of claim 6, wherein the fourth line passes through the first heat exchanger at a front end of the first pressure reducing valve, and
in the first heat exchanger, a liquid refrigerant separated from the separator and flowing along the fourth line, a gaseous refrigerant separated from the separator and flowing along the fifth line, and a mixed refrigerant flowing along the sixth line are heat-exchanged.

15. The liquefied gas supercooling system of claim 14, wherein the de-icing unit includes a fifth bypass valve, and
the fifth bypass valve is provided on a fifth bypass line branched from at least one of the fourth line, the fifth line, and the sixth line and connected to the fourth line at the front end of the first pressure reducing valve or the rear end of the first pressure reducing valve.
